(19) United States
(12) Patent Application Publication
(10) Pub. No.: US 2020/0399843 A1
(43) Pub. Date: Dec. 24, 2020

(54) CONTROL SYSTEM FOR WINTER MAINTENANCE VEHICLE

(71) Applicant: Flo-Draulic Controls Ltd., Georgetown (CA)

(72) Inventor: Chris Passmore, Georgetown (CA)

(21) Appl. No.: 16/904,144

(22) Filed: Jun. 17, 2020

Related U.S. Application Data
(60) Provisional application No. 62/862,790, filed on Jun. 18, 2019.

(51) Int. Cl. E01H 5/06; B60Q 9/00; E01H 5/10

(52) U.S. Cl. CPC E01H 5/061; E01H 5/10; B60Q 9/008

(57) ABSTRACT

A control system for a vehicle is provided. In one aspect, the control system includes a sensing mechanism for detecting an amount of material dispensed. The detected amount is compared to a desired dispensing amount in a profile created based on a number of relevant factors. The output rate of the material is varied to minimize discrepancies between the detected output amount and the desired amount. In another aspect, the control system includes a sensor array for determining the positions of the plow blades and objects in the path of a snow removal vehicle. The sensor data is used to determine a potential for collision, in which case a signal is sent to vary the positions of one or more of the blades to minimize vehicle footprint and help to avoid a collision.

### CROSS-REFERENCE TO RELATED APPLICATION(S)

This application claims the benefit of U.S. Provisional Application No. 62/862,790 filed on Jun. 18, 2019, which is incorporated by reference herein in its entirety.

### TECHNICAL FIELD

The present disclosure relates to a control system for winter maintenance vehicles, specifically a control system adapted for improved safety and efficiency of snow plow vehicles.

### BACKGROUND

Winter maintenance vehicles, such as snow plows, are used to remove snow and ice from roadways, sidewalks, parking lots, etc. Snow plow vehicles are mostly manually operated on-road vehicles where the operators drive the vehicle, control the plow blade, and activate salt or brine dispensing. The manual multitasking by the operator leads to concerns over safety, operational efficiency, and environmental impact.

In regards to safety concerns, snow plow vehicles are often large in size and may be difficult to navigate through narrow city streets that are often congested with obstacles such as curbs, signs, light posts, parked cars, etc. Further, snow plow vehicles often operate under adverse weather conditions where road conditions are at their most treacherous, which demand the operator's utmost attention. As mentioned, the operator may also have the added responsibility of operating various vehicle components, such as de-icing/snow removal material dispensers. The foregoing is likely to result in an elevated level of snow plow related incidents that may be of considerable cost to municipalities and that could also result in personal injuries. In some cases, medium to large sized municipalities pay an average of $500,000 a year in damaged property claims and settlements from accidents caused by snow plow vehicles.

With respect to operational efficiency and environmental impact, it is understood that the manual operation of salt or brine dispensing units by the snow plow operator is inexact and often leads to over application. Not only does over-salting or over application result in increased cost, its negative environmental impact is also well known. Salt distribution is often inexact because the current solutions lack closed-loop salt measurement and control. Currently, about five million tonnes of road salt are used in Canada each year, which costs approximately $250 million dollars. Over $5 billion dollars of damages to Canadian infrastructure may be directly attributable to salt on the roadways.

Over-salting can also lead to increased salinity in waterways, causing irreparable harm to wildlife and the environment. If municipalities could measure the amount of salt applied to roads and work to reduce it, there would be a significant benefit to their operating costs, their townships and the environment.

Accordingly, there is a need for an improved snow plow vehicle control system which enhances vehicle operation safety and minimizes vehicle operator responsibilities with regards to non-driving tasks.

### SUMMARY

To at least partially overcome some of the above-mentioned challenges, in one aspect, the present disclosure provides a winter maintenance vehicle control system that reduces de-icing/snow removal material dispensing control from the operator's responsibility. The dispenser operation may be monitored to determine the amount of de-icing/snow removal material dispensed and used to regulate the rate at which the material is dispensed. The closed-loop system may automate the material dispensing procedure by being able to apply quantifiable amounts of de-icing/snow removal material on the roads more consistently. In some embodiments, the material dispensing operation may also be varied based on a pre-determined profile containing desire dispensing volume data based on geographical locations with corresponding weather data and other relevant factors, which may increase the safety of operators, minimize municipality liability, increase operational efficiency, and reduce material costs.

In some further embodiments, the material dispensing operation decisions for one or more winter maintenance vehicles may be determined and/or coordinated at a centralized command center rather than at each local truck. The use of a centralized command center ensures someone is observing the trucks and their functions. If the weather changes, a central agent is able to respond and makes changes accordingly. This may be done using a cloud base server.

In another aspect, the present disclosure provides a winter maintenance vehicle control system with a collision avoidance feature. Specifically, an array of sensors may be incorporated into the vehicle so as to enable the control system to differentiate between accumulation of snow and ice from objects to be avoided. In some embodiments, the identification of objects to avoid may be made even though the object is partially or fully covered in snow. In further embodiments, radar sensors may be used since they are able to penetrate through snow and ice and reflect energy back. In some embodiments, a control signal may be sent to change the position of one or more of the plow blades to avoid potential collisions. In other embodiments, the vehicle operator may be notified of a possible collision in order to enable them to take corrective action. In other embodiments, LiDAR is used.

In a still further aspect, the present disclosure provides a control system for a winter maintenance vehicle having a dispenser for dispensing a material, the dispenser being connected, via an output path, to a storage unit for storing the material, the storage unit having at least an opening for allowing the material to flow therefrom to the output path, the opening controlled by at least one control valve, the control system comprising: a sensing mechanism configured to detect an amount of material dispensed through the output path; and a controller operatively coupled to the control valve and the sensing mechanism, the controller configured to send a control signal to the control valve based on the detected amount of dispensed material.

In a still further aspect, the present disclosure provides a control system for a winter maintenance vehicle that includes a plow, the control system comprising (i) a sensor array comprising a first sensor configured to determine the plow position relative to the vehicle, and a second sensor configured to detect a plurality of encountered objects; and (ii) a controller coupled with the sensor array, the controller configured to determine a footprint of the vehicle based on the plow position, to make an identification with respect to the plurality of encountered objects, and to determine potential collisions based on the determined footprint and identification.

This footprint may be dynamically based on the extension and retraction of the blades. Movement of the wing also often greatly changes the width of the vehicle. The controller is further configured to assess a likelihood of collision based on the determined footprint and identification.

In a further aspect of the present disclosure, a control system is provided with collision avoidance feature. Even though automobile collision avoidance systems are well known in the art, existing systems are often unsuitable for the operating conditions associated with winter maintenance vehicles such as snow plow vehicles. Specifically, the accumulation of snow and ice on road surfaces could trigger false detection, which could lead to inefficient snow/ice removal operation as piles of snow and ice are avoided and not removed. Further, irregular shapes/outlines of snow/ice accumulation may also not serve as a distinguishing feature since common snow plow collision objects, such as parked vehicles, guardrails, and base of light posts, may be partially or completely buried under snow and ice. The inability of existing collision avoidance systems to distinguish between obstacles and snow/ice accumulation may lead to collisions and property damage as well as potential injuries.

The present disclosure presents an improved collision avoidance system for a snow plow vehicle control system that at least partially addresses some of the deficiencies of known collision avoidance systems identified above.

### BRIEF DESCRIPTION OF THE DRAWINGS

Reference will now be made, by way of example, to the accompanying drawings which show example embodiments of the present application, and in which:

FIG. 1 is a side elevation view of a snow plow vehicle in accordance with one example embodiment of the present disclosure;

FIG. 2 is a schematic view of the material dispensing components of the snow plow vehicle shown in FIG. 1 in accordance with one example embodiment of the present disclosure;

FIG. 3 is a block diagram of a control system with a material dispensing control feature in accordance with one example embodiment of the present disclosure;

FIG. 4 is a partial isometric view of a sensing mechanism, such as a LiDAR sensor, in accordance with one example embodiment of the present disclosure;

FIG. 5A is a front elevation view of the LiDAR sensor shown in FIG. 4;

FIG. 5B is an example of a graphical representation of an output generated by the LiDAR sensor shown in FIG. 5A;

FIG. 6 is an isometric view of a mounting assembly for attaching the LiDAR sensor shown in FIG. 4 to the snow plow vehicle in FIG. 1; and

FIG. 7 is a block diagram of a control system with an object avoidance feature in accordance with another example embodiment of the present disclosure.

Similar reference numerals may have been used in different figures to denote similar components.

### DETAILED DESCRIPTION

The present disclosure is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine readable medium. Elements referred to in the singular may be implemented in the plural and vice versa, except where indicated otherwise either explicitly or inherently by context.

Other examples and corresponding advantages may be readily discernible in view of the present disclosure.

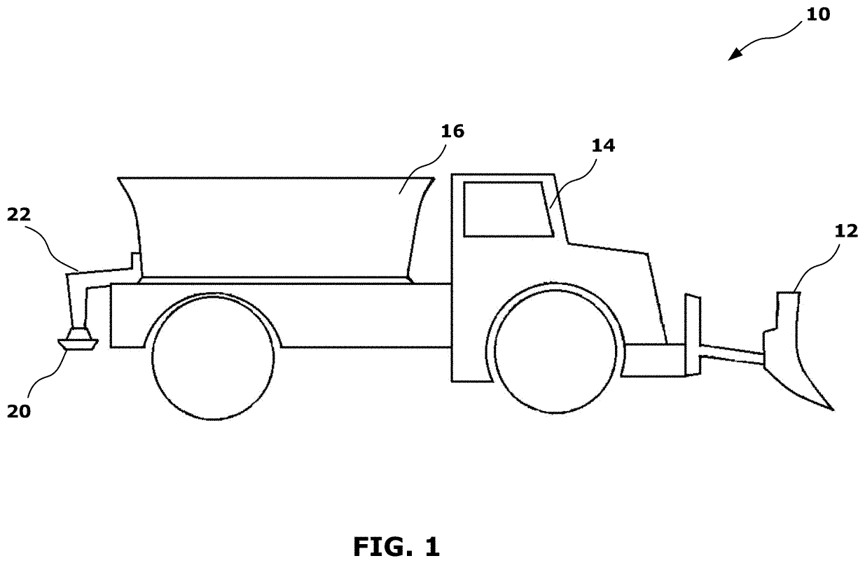

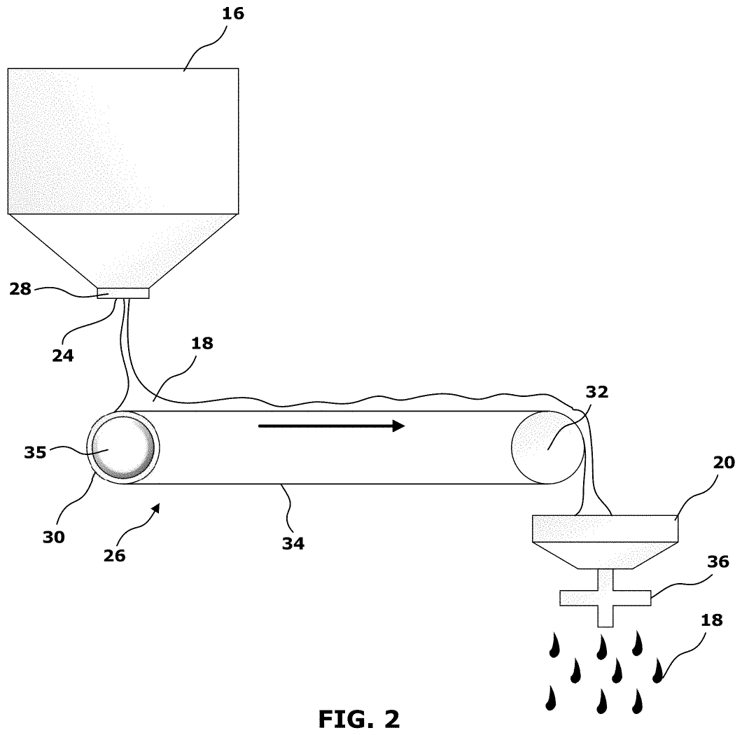

Reference is first made to FIGS. 1 and 2. A winter maintenance vehicle in the form of a snow plow vehicle 10 is provided. It is understood that snow plow vehicles may encompass any vehicle capable of snow removal and/or dispensing de-icing material. The illustrated snow plow vehicle 10 includes a main plow blade 12 that is coupled, often detachably, to an end of the vehicle 10 forward of the cab 14. Although not shown, one or more wing plows may be attached, often detachably, to one side of the vehicle 10. The vehicle operator (not shown) is situated within cab 14, where user interfaces for presenting information regarding the state of vehicle 10, such as vehicle speed, desired, actual and recommended material application rates, spinner speeds and error messages, may reside.

Situated behind cab 14 is often a storage unit or hopper 16 configured for storing a material 18 to be dispensed for de-icing and/or snow removal purposes. In some embodiments, the hopper 16 may be installed in the middle of the vehicle 10, known as a cross-conveyor configuration. As it is known to those skilled in the art, the material 18 may include any suitable mixture or compound having a low freezing point and/or is capable of increasing road surface friction. The material 18 may be in granular form such as rock salt, sand, gravel, and other types of salt (calcium chloride and magnesium chloride). Alternatively, the material may be in liquid form such as brine, a type of salt-based solution, beet juice, or any other liquid used for de-icing/snow removal purposes.

As shown, the hopper 16 is coupled to a dispenser 20 near the back end of the vehicle 10 through an output path 22. It may be appreciated by those skilled in the art that for embodiments with a front discharge or cross conveyor configurations, the dispenser 20 may be positioned between hopper 16 and the cab 14. The dispenser 20 is configured to dispense the material 18 onto a road surface upon which the vehicle 10 travels.

As shown in FIG. 2, the hopper 16 typically has a bottom opening 24, which permits material 18 to flow onto a feed conveyor 26, which transports the material 18 to dispenser 20. Although hopper 16 is shown in the Figures, it is to be understood that any other material storage unit, such as tanks, silos, bins, vessels may be used. The bottom opening 24 of the hopper 16 may generally be controlled by a control valve 28. The control valve 28 may regulate the size of the opening 24, ranging from being completely shut to a maximum diameter, thereby regulating the output rate of the material 18 from the hopper 16. Although control valve 28 is shown in the Figures, it is to be understood that any other suitable mechanism for regulating material output, such as slide gates, may be used. In some embodiments, a metering gate (not shown) which would be adjusted by hand by the operator, on the conveyor belt 34, may also be used to regulate the output rate of the material 18.

At least a portion of the output path 22 may be defined by the feed conveyor 26, which transports the material 18 in the direction as indicated by the arrow towards the dispenser 20. The feed conveyor 26 in the illustrated embodiment includes rollers 30, 32 configured to facilitate movement of a conveyor belt 34. It is to be appreciated that the conveyor belt 34 may be driven by any other appropriate means, such as a chain drive. As is known in the art, at least one of the rollers 30 and 32 is driven by a motor (not shown). The rollers 30, 32 facilitate movement of the conveyor belt 34 in a given direction such as in a clockwise direction as indicated by the arrow in FIG. 2. It is to be appreciated that the output path 22 may include additional components which material 18 may travel. For example, the feed conveyor 26 may transport material 18 onto a conduit, which facilitates the material 18 entering dispense 18 by the force of gravity or any other suitable method of delivering the material 18 to the dispenser 20. A conveyor encoder 35 is shown to be connected to roller 30. It is to be understood that the encoder 35 may be connected to at least one of the rollers 30, 32. The functionality of the encoder 35 will be discussed in more detail below.

Once the material 18 is delivered into the dispenser 20, a rotating member, or a spinner 36, of the dispenser 20 may dispense the material 18 onto a road surface below (not shown). As known to those skilled in the art, the spinner 36 is generally used for material 18 in granular form. For material 18 in liquid form, a spray faucet or any other type of solution dispenser may be used instead of, or in conjunction with, the spinner 36. It is to be appreciated that other forms of dispensing component may be used. The rotation speed of the spinner 36 may depend on the number of lanes across which the material is to be dispensed. The rotating member may include two or more spinners.

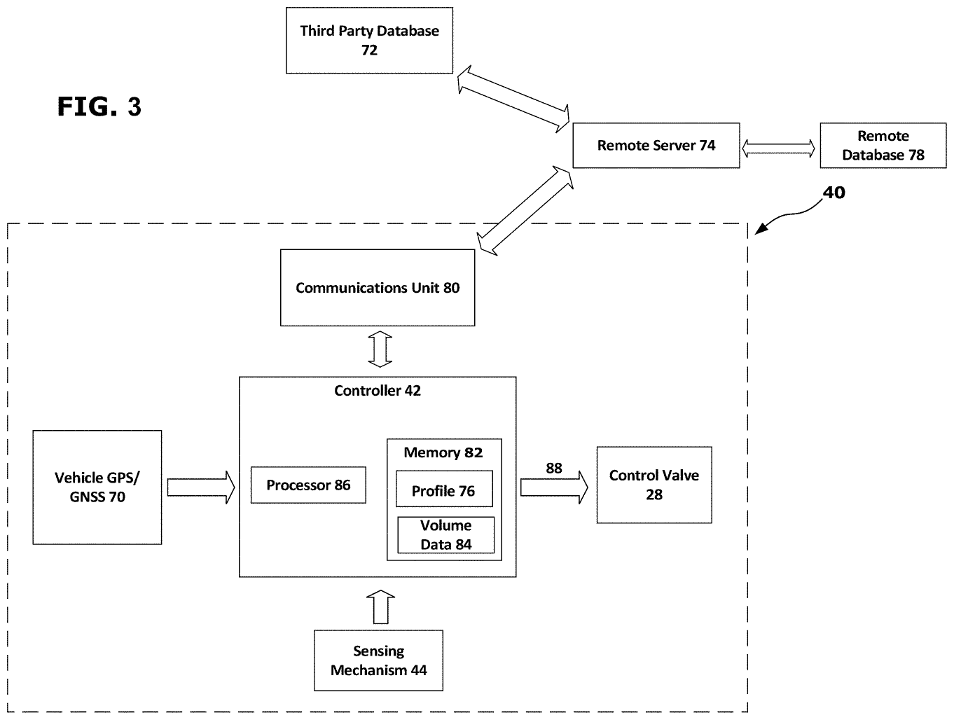

FIG. 3 shows a control system 40 with material dispensing control feature in accordance with one example embodiment of the present disclosure.

In the illustrated embodiment, the control system 40 includes a controller 42 that is in connection with a sensing mechanism 44. The sensing mechanism 44 may be secured proximate to the output path and configured to detect an amount of material 18 outputted from the storage unit to the dispenser 20. For example, in one embodiment the amount of material 18 detected by sensing mechanism 44 may be a volume of material 18 outputted from the storage unit to the dispenser 20.

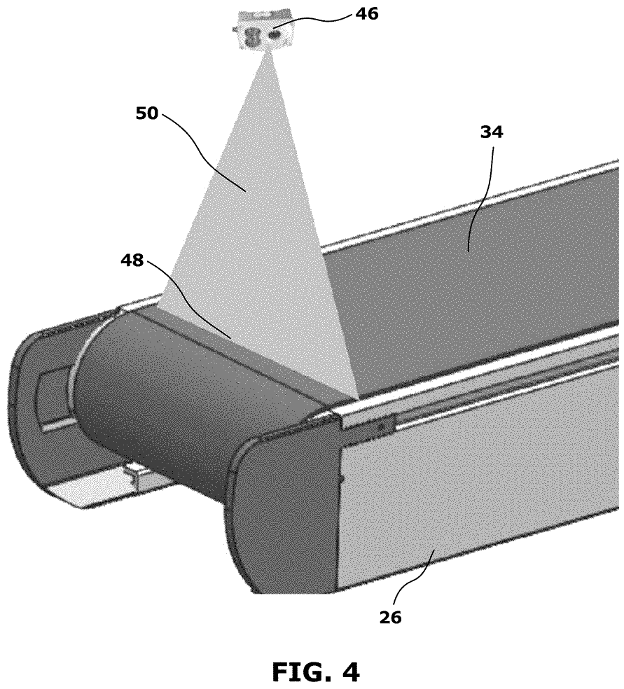

In some embodiments, such as the one shown in FIG. 4, the sensing mechanism 44 may include a Light Detection and Ranging (LiDAR) sensor 46, which may measure distance to a target by illuminating the target with pulsed laser light and measuring the reflected pulses with a sensor. Differences in laser return times and wavelengths can then be used to provide both distance and angular positioning of the target area.

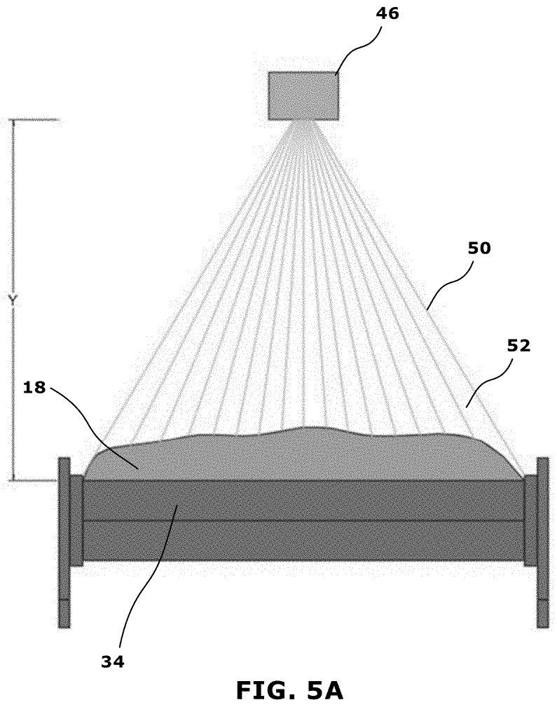

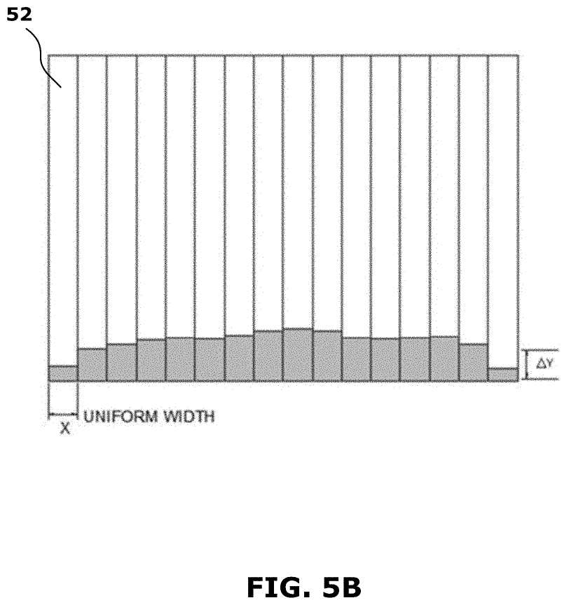

FIG. 5A shows a front elevation view of the LiDAR sensor 46 in FIG. 4. As shown, the LiDAR sensor 46 is positioned over the feed conveyor 26 to monitor an area 48 of conveyor belt 34. The LiDAR sensor 46 may perform continuous analysis over the monitored area 48 and provide corresponding data in real-time over CAN communication. The LiDAR sensor 46 may project a signal 50, such as infrared LED pulses or any other suitable waveform, onto area 48 of the conveyor belt 34 to conduct measurements. As shown, the measurements are performed on 16 independent active segments 52 along the transverse direction (or X-axis) of the conveyor belt 34. The width of segments 52 may be uniform. The segments 52 may also be configured to measure in various units, such as millimeters, centimeters, meters, and inches. It is to be understood that the number of segments 52 and the segment dimensions may be dependent on the height (Y in FIG. 5A) of the LiDAR sensor 46 above the conveyor belt 34, and may vary from that shown in the Figures.

In some embodiments, the LiDAR sensor 46 may first be calibrated by measuring the distance Y to conveyor belt 34 without the presence of any material 18. This initial Y value may be set as a reference distance. After material 18 is dispensed onto the conveyor belt 34 as shown in FIG. 5A, the LiDAR sensor 46 may generate a discrete representation of a cross-sectional area of the material 18 on top of the conveyor belt 34 as shown in FIG. 5B. The LiDAR sensor 46 may detect a height value (ΔY) in the material 18 at a given time. Specifically, as the material 18 passes through monitored area 48, the distance between the sensor 46 and the top surface of the material 18 will differ from the reference distance Y by the height of the material 18, which may be calculated by subtracting the detected height from the reference height value, ΔY. The ΔY value may be generated for each segment 52. The width of segment 52 may be determined by dividing total width of signal 50 on conveyor belt 34 by the total number of segments 52. The cross-sectional area of each segment 52 that is representative of the material 18 may be determined by multiplying the segment width, X, and ΔY. In some embodiments, the height variation values ΔY detected by the LiDAR sensor 46 may be broadcasted to controller 42 via suitable protocol, such as CAN Open, and the determination of the area of each segment 52 may be done at the controller 42.

In order to determine the volume of the dispensed material 18, the depth of the material along the longitudinal direction of the conveyor belt 34 is also determined. In some embodiments, the depth of the material 18 along the conveyor belt 34 may be determined using a conveyor encoder 35, as shown in FIG. 2. The conveyor encoder 35 may provide a pulse stream (for an incremental encoder) or a digital word (for an absolute encoder) that corresponds to the displacement of the conveyor motor shaft (not shown). After determining the physical distance, L, traveled by one rotation of the conveyor roller 30, 32, the pulse stream or digital word can then be converted to distance travelled, D, as is known in the art.

Hence, a volume of the dispensed material 18 can be determined by using V=ΔY*X*D for each segment 52. Summation of the volume, V, for all segments 52 would provide the total volume snapshot per encoder pulse.

The amount of material 18 outputted from the storage unit to the dispenser 20 and detected by sensing mechanism 44 is described above as one of volume. As understood by the skilled person, in alternate applications, the amount of material 18 detected by sensing mechanism 44 may instead by one or more of volume, weight, area, and density of material 18.

For material 18 in liquid form, the sensing mechanism 44 may include any suitable liquid flow sensor, such as an inline flow meter, which may be used to measure volumetric flow rate of a liquid or gas.

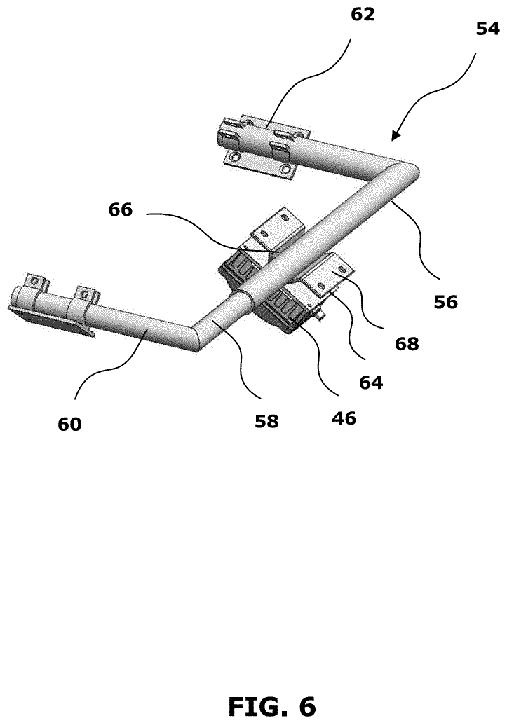

FIG. 6 shows one embodiment of a mounting assembly 54 that may be used for attaching the LiDAR sensor 46 to the vehicle 10. In the illustrated embodiment, the mounting assembly 54 includes a U-shaped mounting bar 56 defined by a transverse section 58 with two longitudinal arms 60 extending from the two ends of the transverse section 58. The mounting bar 56 may be mounted onto the vehicle 10 by mounting plates 62 positioned on the free end of the longitudinal arms 60 as shown. In the illustrated embodiment, the LiDAR sensor 46 is coupled to the mounting assembly 54 through a rotatable mounting plate 64. The rotatable mounting plate 64 includes a generally semicircular section 66 flanked by two coupling flanges 68. The semicircular section 66 may be configured to fittingly receive, and capable of rotating about, a portion of the transverse section 58 of the mounting bar 56 as shown. By rotating the rotatable mounting plate 64 about the transverse section 58, the angle at which the LiDAR sensor 46 is aimed at the conveyor belt 34 may be adjusted. A cover mounting plate (not shown) may be coupled to the coupling flanges 68 via fasteners (not shown), encasing a portion of the transverse section 58 of the mounting bar 56 therebetween to maintain a desired sensor angle.

It is to be understood by those skilled in the art that any other suitable forms of mounting mechanisms for positioning the sensing mechanism may be used. The mounting assembly 54 may be customized to allow the sensor 46 to be configured physically for optimum sensing angle and distance away from feed conveyor 26. In some embodiments, the LiDAR sensor 46 may be mounted onto the hoist cylinder between the cab 14 and the hopper 16. In some other embodiments, the sensor 46 may be mounted onto the metering gate. The sensor 46 may also be mounted to any other location on the vehicle 10 so long as the sensor is capable of monitoring the output path 22. A pneumatic device may be mounted proximate to the sensor 46 in order to produce a constant air flow past the sensor 46 to ensure the sensor 46 stays clean.

Referring back to FIG. 3, the controller 42 may correlate the dispensed material volume data from the sensing mechanism 44 with positioning data of the vehicle 10 generated from an onboard location system 70, such as a Global Positioning System (GPS) or a Global Navigation Satellite System (GNSS). The correlation of material volume and location may provide a profile governing the de-icing/snow removal material distribution over a route travelled by the snow plow vehicle 10. The material distribution volume data may then be used to control one or more aspects of the dispenser 20 operation. The profile may be uploaded to a remote server 74 from the truck through GSM communication.

In some embodiments, information from available a third-party database 72 may be obtained by the remote server 74 and used to create a pre-determined de-icing/snow removal material application profile 76 by remote server 74. In some embodiments, the remote server 74 may be a cloud-based web server with corresponding web applications to handle queries, such as in a SQL format, firebase, firecloud, from snow plow vehicles 10.

The profile 76 may comprise information on desired volume of de-icing/snow removal material for sections of a route. The volume information in the profile 76 may be based on one or more of historical data, predicative modelling, environmental sensitivity, or another suitable basis. With respect to the third-party database 72, by way of a non-limiting example, the Ministry of Transportation of Ontario, Canada (MTO) maintains a Road Weather Information System (RWIS) which utilizes a network of road sensors, meteorological sensors, and cameras to monitor and collect weather information on roadways. In addition, weather forecast information may also be readily obtainable from various meteorological agencies, and may be integrated with the road weather information to generate a desirable salt/brine application profile 76 that may permit efficient use of de-icing/snow removal resources with improved effectiveness.

This information may be received through the remote service bidirectional communication. In some embodiments, real time changes can be made to the de-icing application. If the weather forecast worsens, a storm severity slider may be used. Each road is classified into a category to determine how much of each de-icing material should be dispensed. This feature includes predetermined set amounts to increase the dispensed material 18 when the slider is activated.

The generated profile 76 may be stored in a remote database 78. The profile 76 may be communicated to controller 42 via a vehicle communication unit 80. The profile 76 may be stored locally within a computer-readable memory 82 onboard the controller 42 such that when communication link with the remote server 74 is unavailable, de-icing/snow removal material dispensing operation may still commence. The memory 82 may also be used to store dispensed material volume data 84 as generated from the sensing mechanism 44. Volume data 84 may be in any suitable format, such as SQL data. In some embodiments, dispensed material volume information 84 may be uploaded from controller 42 to remote server 74 via communication unit 80. The remote server 74 may use the uploaded information to update existing profiles 76 or to be taken into consideration for future profiles 76. Subject to availability of communication link between communication unit 80 with the remote server 74, the profile 76 stored in memory 82 may be periodically updated based on the most recent data obtained from the third party server or database 72. For example, profile 76 may be updated on a week-to-week, day-to-day, or hour-to-hour basis, or continuously updated in real-time. In some embodiments, the vehicle GPS/GNSS data may also be uploaded to remote server 74 such that any uploaded dispensed material volume data 84 may be correlated with the location data by the remote server 74. Additionally, by locally storing the profile 76, the snow plow vehicle 10 may continue to execute de-icing/snow removal operation in offline mode where a communication link with the remote server 74 is unavailable.

In some embodiments, routes to be travelled by the snow plow vehicle 10 may be generated based on needs as determined with the road weather information and weather forecast. In other words, routes may be created for a given salt/brine application profile. Alternatively, a predetermined route may be created based on other factors, such as traffic volume and/or environmental sensitivity, and a corresponding salt/brine application profile may be created for the specific route. Further, in some instances as weather and road conditions change, real time changes could be made to application rates and profiles where a predetermined rate and profile has been provided to a vehicle. Heat maps, trends, and overall salt usage can be prepared for operational purposes, on a daily, shift-based, or seasonal basis.

The controller 42 may comprise a processor 86 which may be used to determine the dispensed material volume data 84 based on the sensing data provided by the sensing mechanism 44. Further, in some embodiments, the processor 86 may compare the dispensed material volume data 84 with that of the profile 76 and determine whether a discrepancy exists between the desired dispensing volume and the detected dispensed volume. The controller 42 may be connected to the control valve 28 of the hopper 16 such that the controller 42 is capable of sending a control signal 88 to the control valve 28 to change the size of opening 24 and thereby control the output rate of the material 18. The control signal 88 may be based on the CAN-bus protocol, which may be compatible with existing vehicle communication network. The control signal 88 may be generated based on the determined discrepancy between monitored material dispensing volume and the desired dispensing volume in the profile 76, and sent to the control valve 28 over the vehicle communication network.

By way of non-limiting examples, should the dispensed volume data 84 for a given location along a route exceed its corresponding desired volume as indicated by the profile 76, the controller 42 may send the signal 88 to the control valve 28 to decrease material output rate by decreasing the size of the hopper opening 24. Alternately, should the dispensed volume data 84 for a given point be less than its desired volume, as indicated by profile 76, the controller 42 may send a control signal 88 to control valve 28 to increase the size of the hopper opening 24.

In a further aspect of the present disclosure, a control system is provided with collision avoidance features. Even though automobile collision avoidance systems are well known in the art, existing systems are often unsuitable for the operating conditions associated with winter maintenance vehicles, such as snow plow vehicles. Specifically, the accumulation of snow and ice on road surfaces could trigger false detections, which could lead to inefficient snow/ice removal operation as piles of snow and ice are avoided and not removed. Further, irregular shapes or outlines of snow and/or ice accumulation may also not serve as a distinguishing feature, since common snow plow collision objects, such as parked vehicles, guardrails, and the base of light posts, may be partially or completely buried under snow and ice. The inability of existing collision avoidance systems to distinguish between obstacles and snow/ice accumulation may lead to collisions and property damage as well as potential injuries.

The present disclosure presents an improved collision avoidance system for a snow plow vehicle control system that at least partially addresses some of the deficiencies of known collision avoidance systems identified above.

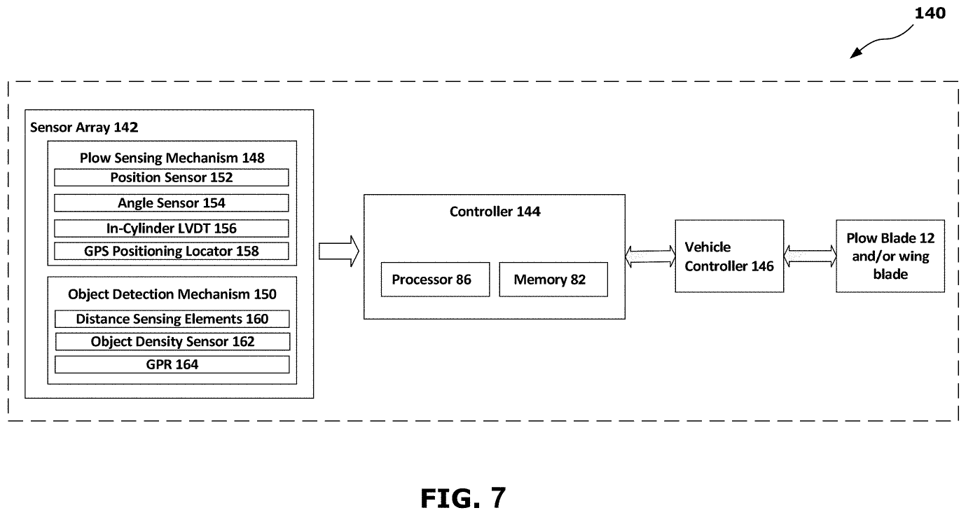

FIG. 7 illustrates a block diagram of a control system 140 in accordance with one embodiment of the present disclosure. Control system 140 includes a sensor array 142 that is functionally coupled to a controller 144, which in turn is connected to a vehicle controller 146.

The sensor array 142 includes a sensor to detect a plow position 148 and a sensor to detect incoming objects 150.

The plow sensing mechanism 148 is configured to detect plow positions of the main plow blade 12 as well as any wing plows in real-time. In some embodiments, the plow sensing mechanism 148 may include in-cylinder LVDTs (Linear Variable Displacement Transducers) 156 to determine cylinder stroke. The cylinder stroke measurements may be translated, by controller 144, into positional information in relation to the vehicle 10. In some further embodiments, to detect the position of the plow blades, the plow sensing mechanism 148 may include at least a position sensor 152 in combination with an angle sensor 154. In some embodiments, plow sensing mechanism 148 may be arranged in a “heel-and-toe” blades sensing configuration on the front and mid-rear plow blades. In some embodiments, a real-time GPS positioning locator 158 may be used, whereby the controller 144 may continuously track the position of the main plow blade 12 and wings in real-time.

The object detection mechanism 150 may be configured to detect objects within the travelling path of the snow plow vehicle 10. The object detection mechanism 150 may include a plurality of distance sensing elements 160 to permit the controller 144 to perform real-time signal processing of all distance measurement data provided by distance sensing elements 160 simultaneously so as to map the immediate area of concern, such as in front or to the side of the vehicle 10, and may designate the series of measurements as an “object”. In the case of snow plows, detecting an object to avoid has an additional level of complexity. As mentioned above, there is a need for the ability to distinguish between objects to avoid from accumulations of snow and ice.

In some embodiments, in addition to the plurality of distance sensing elements 160, the object detection mechanism 150 may include at least one object density sensor 162 that is capable of detecting object density. The controller 144 may be calibrated with the density value of snow and ice as a reference point, to enable it to perform object identification based on a density value greater than the reference point.

In some embodiments, the object detection mechanism 150 may include ground penetrating radars (GPR)s 164 capable of detecting depth, size, and material characteristics of objects under snow cover.

The controller 144 may be configured to receive the plow positional information and the object detection identification data, and to utilize them to determine a likelihood of collision with one or more identified objects to avoid. Specifically, in combination with the known dimensions of vehicle 10, the plow positional information may be used to determine, by controller 144, a footprint of the snow plow vehicle. The footprint would then be used to project the path of the vehicle based on vehicle data as provided by the vehicle controller 146, which may be in bi-directional communication connection with the controller 144. By way of non-limiting example, readings from the vehicle speedometer, groundspeed sensors, J1939 ECU messaging, and steering mechanism may be used to generate a projected path of the vehicle 10. The projected path may be overlain with the object identification to determine the likelihood of collision.

In some embodiments, when a potential collision is detected, a warning signal may be sent to a Human Machine Interface (HMI) situated within the cab 14, to notify the vehicle operator. In some further embodiments, the controller 144 may be configured to send a control signal to the vehicle controller 146 to automatically adjust the plow blade angle so as to minimize the footprint of the vehicle 10 and thereby avoid the potential collision, independent of operator control. In other instances, signals could be sent to the vehicle's braking and/or engine speed control systems in an attempt to avoid a collision.

The potential collision detection speed may be taken into account in order to allow the operator time to react and take evasive maneuvers if necessary. For example, the maximum speed for a successful notification may be calibrated for 100 km/h with the minimum distance for collision warning being 50 m. It is to be understood that the foregoing values may vary based on the speed limits, operating limits, maneuverability of the snow plow vehicle, road conditions, etc.

In some embodiments, the controller 144 may be implemented using 32-bit microprocessors, or better, and utilize a lean approach to the algorithm design to minimize processing time and enable real-time signal processing.

In addition to the above-mentioned sensing elements, the sensor array 142, the plow sensing mechanism 148, and the object detection mechanism 150 may include vision, ferrous, LiDAR, radar and/or various other sensing options. Further, any of the above-disclosed sensing elements may be implemented using suitable integrated sensors that are capable of performing the sensing functionalities of one or more of the above-disclosed sensors.

Certain adaptations and modifications of the described embodiments can be made. Therefore, the above discussed embodiments are considered to be illustrative and not restrictive.

What is claimed is:

1. A control system for a vehicle having a dispenser for dispensing a material, the dispenser being connected, via an output path, to a storage unit for storing the material, the storage unit having at least an opening for allowing the material to flow therefrom to the output path, the opening controlled by at least one control valve, the control system comprising:
a sensing mechanism configured to detect an amount of material dispensed through the output path; and
a controller operatively coupled to the control valve and the sensing mechanism, the controller configured to send a control signal to the control valve based on the detected amount of dispensed material.

2. The control system of claim 1, wherein the controller contains a profile governing the dispensing of the material.

3. The control system of claim 2, wherein the profile contains a desired volume of the material to be dispensed.

4. The control system of claim 3, wherein the controller is further configured to determine a discrepancy between the amount of dispensed material and the desired volume to be dispensed in the profile, and wherein the control signal is sent to the control valve in response to the determined discrepancy.

5. The control system of claim 2, wherein the profile is based on historical dispensing data, predictive modeling, environmental sensitivity, road weather condition, and/or weather forecast.

6. The control system of claim 2, wherein the profile is updated based on data obtained via wireless communication with a remote server in real-time.

7. The control system of claim 6, wherein the data obtained from the remote server includes weather forecasts, traffic volume, and/or environmental sensitivity.

8. The control system of claim 1, wherein the detected amount of dispensed material is correlated with a location of the vehicle to create a profile covering material distribution over a route travelled by the vehicle.

9. The control system of claim 1, wherein the material is a granular material, and the sensing mechanism includes a Light Detection and Ranging (LiDAR) sensor and a conveyor encoder.

10. The control system of claim 1, wherein the material is a liquid mixture, and the sensing mechanism is an inline flow meter.

11. The control system of claim 9, wherein the LiDAR sensor determines a height value of the material on the output path.

12. A control system for a winter maintenance vehicle that includes a plow, the control system comprising:
(I) a sensor array comprising a first sensor configured to determine a plow position of the plow relative to the vehicle, and a second sensor configured to detect a plurality of encountered objects; and
(i i) a controller coupled with the sensor array, the controller configured to determine a footprint of the vehicle based on the plow position, to make an identification with respect to the plurality of encountered objects, and to determine a potential collision based on the determined footprint and identification.

13. The control system of claim 12, wherein the controller generates a control signal to change the plow position to minimize the footprint in order to avoid the potential collision.

14. The control system of claim 13, wherein the vehicle further includes a wing blade and the sensor array of the control system further comprises:
a third sensor configured to determine a wing blade position of the wing blade relative to the vehicle;
wherein the footprint determination is based on the plow position and the wing blade position; and
the control signal changes the position of the wing blade to minimize the footprint.

15. The control system of claim 12, wherein the second sensor is any one of a density sensor, a GPR sensor, a ferrous sensor, a Light Detection and Ranging (LiDAR) sensor, and a vision sensor.

16. The control system of claim 12, wherein the first sensor includes a linear variable displacement transducer (LVDT) configured to predetermine a cylinder stroke, wherein the plow position is determined based in part on the cylinder stroke.

17. The control system of claim 12, wherein the first and second sensors are arranged to detect heel and toe blade positions.

18. The control system of claim 12, wherein the determination of the potential collision is done in real-time.

19. The control system of claim 12, wherein the sensor array includes an integrated sensor, the integrated sensor being configured to function as the first sensor and as the second sensor.

20. The control system of claim 12, wherein the controller is further configured to notify a vehicle operator of the determined potential collision.
